(19) United States
(12) Patent Application Publication
(10) Pub. No.: US 2021/0274619 A1
(43) Pub. Date: Sep. 2, 2021

(54) SOLAR MOTION LIGHT WITH A REMOTE CONTROL

(71) Applicant: LES PRODUITS SUNFORCE INC., Montreal-Ouest (CA)

(72) Inventors: Simon BAILEY, Montreal (CA); Michael DAHAN, Hampstead (CA)

(21) Appl. No.: 17/183,037

(22) Filed: Feb. 23, 2021

Related U.S. Application Data
(60) Provisional application No. 62/982,330, filed on Feb. 27, 2020.

(51) Int. Cl. H05B 47/115; H05B 47/19; H05B 47/11; F21S 9/03

(52) U.S. Cl. CPC H05B 47/115; H05B 47/19; F21V 23/0435; F21S 9/037; H05B 47/11

(57) ABSTRACT

An exterior light operable with a remote comprises a light panel assembly, a motion detector for detecting movement in an area of the exterior light and a control panel comprising controls for selecting a mode of operation of the exterior light. The exterior light comprises a housing enclosing a battery powering the light panel assembly. Modes of operations of the exterior light comprise a time duration and conditions in which the battery is used to power the exterior light panel assembly upon the motion detector sensing movement. A remote control allows to override the mode of operation from the control panel for a given period.

### CROSS-REFERENCE TO RELATED APPLICATION

This application claims priority from U.S. provisional patent application 62/982,330 filed Feb. 27, 2020, the specification of which is hereby incorporated herein by reference in its entirety.

### BACKGROUND

### (a) Field

The subject matter disclosed generally relates to solar-powered exterior lights. More specifically, it relates a remote control and a local control for a motion-activated solar-powered exterior light.

### (b) Related Prior Art

There are solar-powered exterior lights used for the purpose of lighting outdoor locations upon detecting movement in the location. This is often useful in cases where there is no electric plug to connect the exterior light, in which case the solar-powered battery becomes particularly useful for the exterior light. In this case, the use of a motion detector ensures that the electrical power is used for lighting only when needed.

The simplicity of the apparatus may be hard to conciliate with the needs for proper controls of the device. Typically, on ON/OFF button is available to turn the apparatus on or off.

### SUMMARY

According to an embodiment, there is provided an exterior light comprising: a light panel assembly; a battery for storing energy to power the light panel assembly; a motion detector for detecting movement in a monitored area close to the exterior light, the motion detector comprising a motion sensor housing; a control panel provided on the motion sensor housing and comprising controls for selecting a mode of operation of the exterior light, the mode of operation determining a time duration and conditions in which the battery is used to power the light panel assembly depending on the motion detector; and a remote control detached from other parts of the exterior light for overriding the mode of operation from the control panel for a given period.

According to an aspect, the remote control comprises at least one control component comprising one of a push button, an interactive graphical interface and a touch screen control.

According to an aspect, the remote control comprises a number of control components that is less than a number of controls of the control panel.

According to an aspect, the remote control is adapted to override the mode of operation from the control panel with one of a plurality of override modes of operations.

According to an aspect, the mode of operation comprises a combination of at least two of: lighting duration; lighting intensity; ambient light sensitivity and motion detection sensitivity.

According to an aspect, the exterior light further comprises a controller wherein the remote control transmits wireless signals to the controller to override the mode of operation.

According to an aspect, the remote control comprises a wire connected to the control panel for transmitting wired signaled through the wire to override the mode of operation.

According to an aspect, the exterior light further comprises an ambient light detector, and wherein the mode of operation depends further on the ambient light detector.

According to an aspect, the motion sensor housing is orientable relative to the body assembly.

According to an aspect, the motion sensor housing comprises a bottom, and wherein the control panel is located on the bottom of the housing.

According to an aspect, the exterior light further comprises a power line adapted to be connected to a power source comprising one of a solar panel and alternative current power source.

According to an aspect, the remote control comprises a control component comprising a single push button.

According to an aspect, the remote control comprises a control component comprising one of an interactive graphical interface and a touch screen control.

According to an embodiment, there is provided an exterior light comprising: a body assembly; a light panel assembly, attached to the body assembly, for emitting light; a battery for powering the light panel assembly; a controller for controlling operation of the light panel assembly; a motion detector, connected to the controller, for detecting movement in a monitored area close to the exterior light; a control panel, connected to the controller, comprising a control for selecting a mode of operation of the exterior light in which the battery powers the light panel assembly depending on movement detection by the motion detector; and a remote control detached from other parts of the exterior light for providing a signal to the controller to override the mode of operation with an override mode of operation for a given period.

According to an aspect, the remote control comprises at least one control component comprising one of a push button, an interactive graphical interface and a touch screen control.

According to an aspect, the remote control comprises a number of control components that is less than a number of controls of the control panel.

According to an aspect, the mode of operation comprises an operating condition of the light panel assembly and a time duration during which the battery powers the light panel assembly.

According to an aspect, the operating condition comprises at least one of a lighting mode and a trigger condition.

According to an aspect, the remote control is for receiving a selection the override mode of operation and for transmitting the signal of the override mode of operation among a plurality of override modes of operation.

According to an aspect, the exterior light further comprises an ambient light detector connected to the controller, and wherein powering the light the light panel assembly further depends on the ambient light detector.

According to an aspect, the mode of operation comprises a combination of at least two of: lighting duration; lighting intensity; ambient light sensitivity and motion detection sensitivity.

According to an aspect, the remote control transmits wireless signals to the controller to override the mode of operation.

According to an aspect, the remote control comprises a control component comprising a single push button.

According to an aspect, the remote control comprises a control component comprising one of an interactive graphical interface and a touch screen control.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic perspective view illustrating a motion-activated solar-powered exterior light, according to an embodiment;

FIG. 2 is a perspective view illustrating a motion-activated solar-powered exterior light with a control panel at the bottom of a motion sensor housing, according to an embodiment;

FIG. 3 is a picture showing a front, bottom perspective view illustrating a motion-activated solar-powered exterior light with a control panel at the bottom of a motion sensor housing and a remote control, according to an embodiment;

FIG. 4 is a picture showing a front perspective view illustrating a motion-activated solar-powered exterior light with a motion sensor housing comprising a control panel at its bottom and a remote control, according to an embodiment;

FIG. 5 is a picture showing a bottom perspective view illustrating a control panel at the bottom of a motion sensor housing, according to an embodiment; and

FIG. 6 is a schematic diagram illustrating a control panel for a motion-activated solar-powered exterior light.

It will be noted that throughout the appended drawings, like features are identified by like reference numerals.

### DETAILED DESCRIPTION

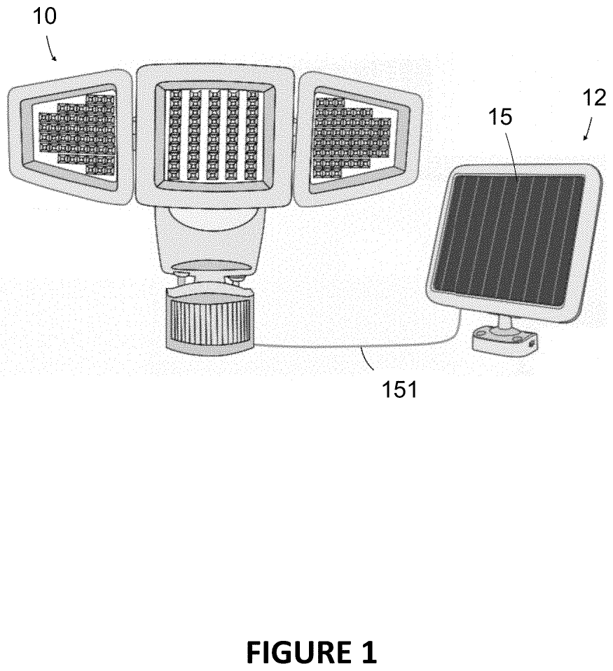

Referring to the drawings, and more particularly to FIG. 1, there is shown a schematic perspective view of an exterior light 10 (shown uninstalled) powered by a solar panel module 12 comprising a solar panel 15, such as a photovoltaic panel which converts incoming sunlight into electrical power. FIG. 1 shows a power line 151 connecting the solar panel module 12 to the exterior light 10 and providing power to the exterior light 10. The solar panel module 12 connected to the exterior light 10 by a power line 151 determine optimal placing for the exterior light 10 and the solar panel module 12 while only passage of power line 151 is left to consider.

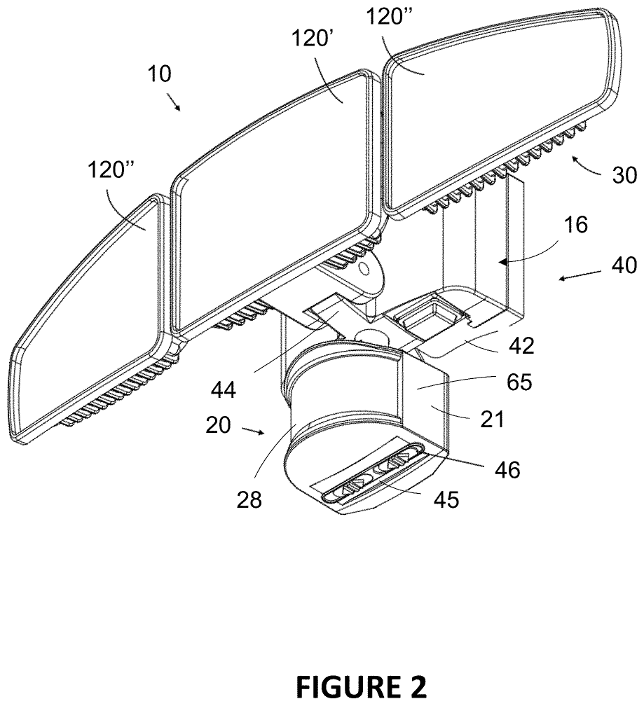

Now referring to FIG. 2, there is shown a perspective view of the electric light fixture, a wall-mounted exterior light 10, according to an embodiment. The exterior light 10 illustrated is intended to be mounted on a wall (not illustrated). The exterior light 10 illustrated may be intended to be powered by a solar panel 15 (see FIG. 1) or through the use of a conventional electrical connection box (not shown) connected to the house or other building electrical circuit thereby providing an alternating current power source.

The exterior light 10 of the illustrated embodiment comprises a motion sensor housing 20, aka control housing, and a light panel assembly 30 having one or more light emitting components 120 pivotally mounted thereon. The light emitting components 120 comprise lights. According to an embodiment, the light emitting components 120 can be oriented independently from each other. According to an embodiment, the lights are light-emitting diodes (LEDs).

Accordingly, in view of the three pivotally mounted light emitting components 120, the exterior light 10 is well adapted to be mounted on exterior walls close to entrances and exits, close to windows and areas to be lit when movement is detected in the vicinity thereof. The exterior light 10 further comprises a body assembly 40 housing the battery 16 therein (not shown) and through which the motion sensor housing 20 and the light panel assembly 30 are coupled to the electrical power and through which the whole exterior light 10 is mounted on the wall. Accordingly, the light panel assembly 30 and the motion sensor housing 20 are orientable relative from the wall through the body assembly 40.

The power source feeding the exterior light 10 with power, e.g., the solar power module 12, comprises a solar panel 15 and a battery (not shown) preferably located in the body assembly 40. The exterior light 10 comprises a body assembly 40 having a front face and a back face according to which the body assembly 40 can be mounted to a wall (vertical or sloped) or a ceiling. The body assembly 40 comprises two complementary mounting components: a base 42 and a joining member 44. The joining member 44 features elements for the motion sensor housing 20, comprising a motion detector 28 for monitoring motion in a monitored area it faces, and the light panel assembly 30 to be mounted thereto. During the installation of the exterior light 10, the joining member 44 and the components attached to the joining member 44, namely the motion sensor housing 20 and the light panel assembly 30, form together an exterior light sub-assembly that may be handled as a single component during that operation.

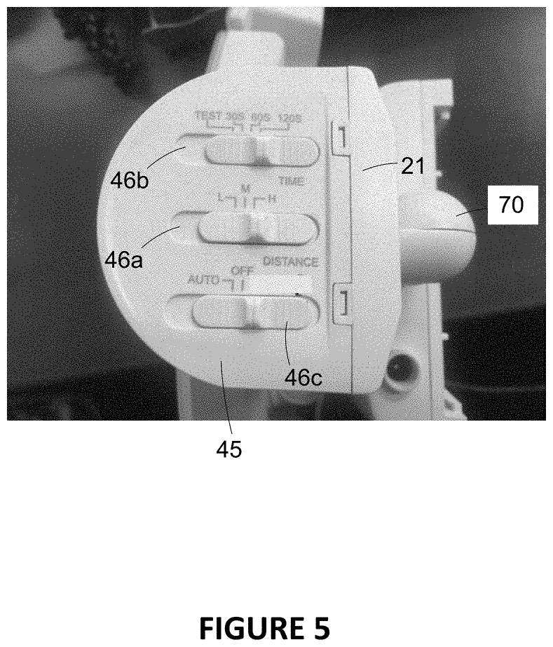

The motion sensor housing 20 is mounted on the joining member 44. It is mounted in a pivotal manner through an articulated coupling sub-assembly 70 (FIG. 5) comprising a top coupling projection coupled to a bottom projection located on the joining member 44. This articulated coupling sub-assembly 70 allows the motion sensor housing 20 to pivot around a first horizontal pivot axis and an angular vertical axis. The pivoting of the motion sensor housing 20 is for adjusting an angle of the motion sensor housing 20 relative to the horizontal and vertical plane. This feature is useful to aim the motion sensor housing 20 in any direction between the horizontal and at an angle aiming toward the ground below in front of the level of the exterior light 10. It is also for aiming the motion sensor housing 20 on either side of the mounting surface normal axis. Thus, optimal area of detection may be set according to the specific use of the exterior light 10, thereby potentially improving consumption of the battery energy and/or security.

The electrical configuration of the exterior light 10 (not illustrated) comprises electrical connections that electrically connect at least the joining member 44, the motion sensor housing 20 and light panel assembly 30, since all these components are or comprise powered components. These electrical connections may consist in exterior wires connecting two different components (e.g., a wire or cable connecting the joining member 44 to the motion sensor housing 20) or may comprise wires embedded in the physical connection elements joining together components. Exterior wires may comprise a combination of electric plug and socket to allow easy connection/disconnection of the components. The electrical connections, once connected, electrically connect the lights/LEDs within the light emitting components 120 of the light panel assembly 30 to the power source and all of its control components.

The light panel assembly 30 comprises joints that join the three light emitting components 120 into a single light panel assembly 30. The light joints physically hold the side light emitting components 120″ onto the central light emitting component 120′, and allow to adjust the orientation of the side light emitting components 120″ relatively to the angle aimed by the central light emitting components 120′. The light joints may comprise a passage for a wire to connect the side light units to the central light unit.

The motion sensor housing 20 further comprises an electrical connection (not shown) through which the motion sensor housing 20 is powered by the battery 16 enclosed in body assembly 40 and connected to the light panel assembly 30.

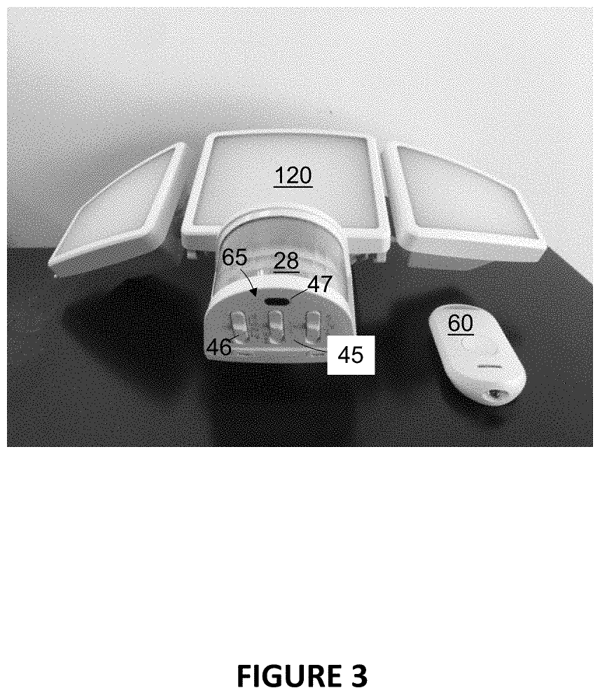

According to an embodiment, as shown on FIGS. 2 and 3, a control panel 45, with at least one control 46, is provided on the motion sensor casing 21. The control panel 45 is preferably located on the bottom side of the motion sensor housing 20. Considering the expected configuration of the exterior light 10, which would be located at a rather high location and in the expected orientation, placing the control panel 45 on the bottom of the motion sensor housing 20 makes it the most accessible location on the entire exterior light 10 while protecting the control panel 45 from undesirable weather conditions.

Now referring to FIG. 5, the control panel 45 comprises controls 46a, 46b, 46c, aka control means, which are buttons, switches or other elements for user interaction and which, individually, allow setting particular functional configurations, aka modes of operation comprising an operating condition and a time duration, for the motion detector 28 by selecting a particular status or configuration for a function. Examples of controls 46a, 46b, 46c may include, without limitation, a push button, a toggle switch, a touch button with light indicators, a slider, a wheel, etc. Each one of the multiple controls 46a, 46b, 46c is independent from the others.

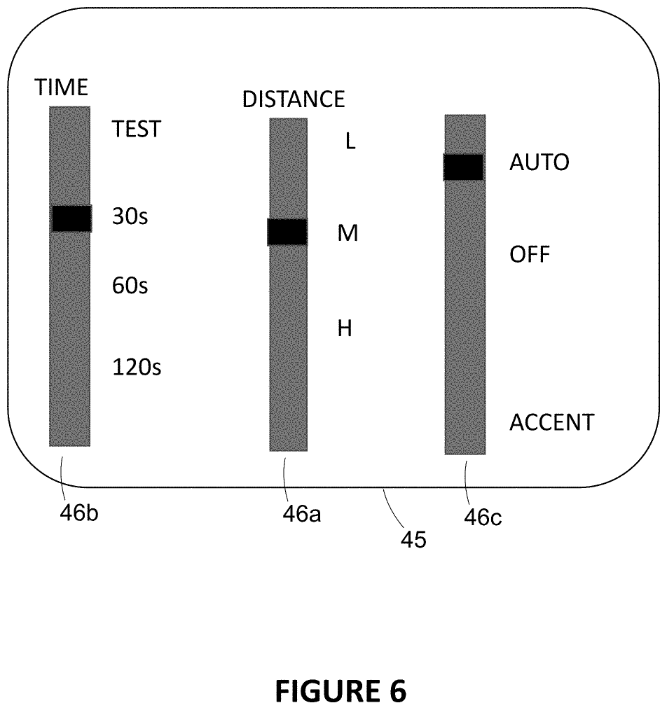

According to an embodiment, a first control 46a is for setting the detection range of the motion sensor housing 20. For example, the detection range may be adjusted by changing the intensity of the radiation used by the motion detector 28. This, in turn, changes the distance up to which an object can be detected as being in motion. For example, as shown in FIGS. 5-6. the distance (or sensitivity) can be set to low (L), medium (M), or high (H), each category corresponding to an approximate distance which corresponds to that category. Alternatively, the label may include a distance or a numerical range of distances instead of a category.

According to an embodiment, a second control 46b is a switch that changes the time duration of a lighting event when motion is detected. Indeed, when motion is detected, the light may light up for a given duration, such as 30 seconds, 60 seconds, or 120 seconds, for example, or even for a short period (test mode). Other suitable time durations are possible, taking into account the fact that the light is powered by sunlight stored in a battery (i.e., long periods such as hours or a great number of minutes should therefore be avoided).

According to an embodiment, a third control 46c is a switch to change the mode of operation of the exterior light 10. As shown in FIG. 5, it can take three settings: an OFF setting, where the light is turned off, and an AUTOMATIC setting, where the light is triggered when movement is detected within the distance range set up by the user, the duration of the lighting being dependent on the duration selected by the user with the other controls. The switch controls remain when the exterior light 10 is lit and when it is not.

As shown in FIG. 6, an additional configuration for the third control 46c may be provided, the “ACCENT” setting. When using this feature, the customer can select “ACCENT” using the third control 46c in the corresponding mode, and the exterior light 10 will then comprise a night light (low intensity) and a motion-detection feature of more intense light. More specifically, the apparatus should comprise an ambient light detector 47, as shown for example in FIG. 3, that detects the ambient light intensity. When the ambient light intensity is low, i.e., under a threshold, the exterior light 10 is then lit up continuously at a low baseline light intensity (i.e., dimmed light or night light, e.g., between, but not limited to, 200 and 300 lumens) to provide a baseline light in the area of operation. The motion detector 28 is used as usual, and upon detecting a movement, the exterior light 10 is operated to increase the light intensity up to a more useful intensity (e.g., between 900 and 1200 lumens, for example). The duration of the higher light intensity may be dependent on the “time duration” setting mentioned above. At the end of the time duration, the light intensity is then brought back down to the baseline light intensity if the night light mode, unless the ambient light intensity is high enough (i.e., above the night threshold) to justify turning off the light completely (i.e., daylight being detected).

Otherwise, another one of the controls (not shown) can be a control for motion detection sensitivity, i.e., the degree of motion triggering the exterior light 10 (such a control is not shown).

Otherwise, another one of the controls (not shown) can be a control for ambient light sensitivity, i.e., the intensity of light triggering the exterior light 10 (such a control is not shown).

Accordingly, according to embodiments, the control panel 45 allows to set lighting duration, and operating condition. The operating condition comprises lighting mode comprising, e.g., lighting intensity; and trigger condition comprising e.g., motion detection sensitivity and/or ambient light sensitivity.

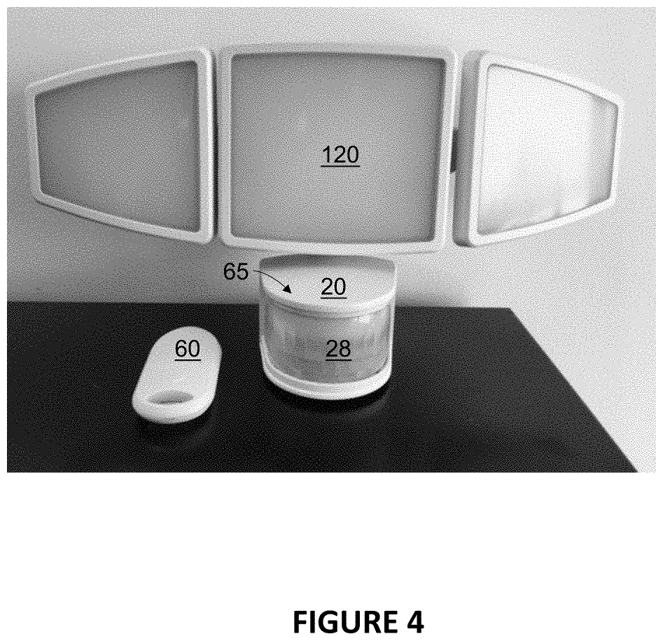

Now referring to FIGS. 3 and 4, there is shown a remote control 60 detached, separate and distinct from a remainder/other parts of the exterior light 10 and to be used within a reasonable range from the exterior light 10. According to an embodiment, the remote control 60 comprises the same controls, aka control components, as the control panel 45. According to another embodiment, the remote control 60 comprises a portion of the controls on the control panel 45.

According to yet another embodiment, the remote control 60 comprises simpler controls, such as a single button, which would be an override operation over the default operating mode set up on the controls 46a, 46b, 46c on the apparatus itself. Indeed, if the switches on the exterior light 10 are manual (mechanical) switches, the remote control 60 cannot change their selected mode. Therefore, the controls of the remote control 60 act as an override. For example, the remote control 60 may comprise a single button which lights up the exterior light 10 for a given period, e.g., selected between 2 and 5 minutes, after which the override mode ends and the operation mode comes back to the one defined by the controls 46a, 46b, 46c on the exterior light 10. The single button of the remote control 60 may also be used to turn off the exterior light 10 or to return it to its selected mode of operation; i.e., press the button once for the override mode (e.g., turn on the exterior light 10 for a given period); press the button again to return the operation to the mode defined by the controls 46a, 46b, 46c.

Accordingly, the remote control 60 allows to override the mode of operation of the exterior light 10 with one override mode of operation for a period, and in embodiments with one override mode of operations among a plurality of available override modes of operations.

According to realizations, the remote control 60 communicates with the controller 65 described hereinafter using one of radio-frequency signals, signals transmitted over Wi-Fi (whereby the remote control 60 may be embodied by a computer, a tablet or a smart phone and may use an interactive graphical interface activable using a keypad, a mouse or a touch screen for examples), according to ZigBee™ protocol or any other similarly appropriate wireless communication standards. Alternatively, the remote control 60 may be wired to e.g., the light panel assembly 30 wherein the remote control 60, distant from the light panel assembly 30, allowing to easily transmit an override signal to the controller 65.

This may be useful if the exterior light 10 is hardly accessible and the person needs a proper lighting for a few minutes. This may be useful too if a person wants to move in an area not in the angular detection range of the motion detector 28, while needing the benefit of the lighting. It is also contemplated that for other commands, the single button may be double tapped, tripled tapped, or press continually for a period (e.g., 3 seconds) until a beep sound is heard.

By maintaining all essential operation modes on the control panel 45 of the exterior light 10, and by giving to the remote control 60 only the possibility of temporarily overriding the controls 46a, 46b, 46c of the control panel 45 for a given period, the exterior light 10 may still be operated if the remote control 60 is lost, which is a real possibility.

The sharing of functions between the remote control 60 and the control panel 45 on the exterior light 10 appears as an appropriate trade-off between simplicity and functionality.

In addition to a battery 16 for storing the electrical energy collected by the solar panel 15, the exterior light 10 should also comprise a controller 65. The controller 65 is preferably an electronic printed board (PCB) that implements the operation modes selected on the controls 46a, 46b, 46c, thereby being connected to the controls 46a, 46b, 46c and also connected to the battery 16 for managing the power output from the battery 16 to control the illumination. In the embodiment comprising a remote control 60, the controller 65 should comprise a receiver to receive the wireless signals from the remote control 60 (such as any one of the command signals described hereinbefore).

While preferred embodiments have been described above and illustrated in the accompanying drawings, it will be evident to those skilled in the art that modifications may be made without departing from this disclosure. Such modifications are considered as possible variants comprised in the scope of the disclosure.

1. An exterior light comprising:
a light panel assembly;
a battery for storing energy to power the light panel assembly;
a motion detector for detecting movement in a monitored area close to the exterior light, the motion detector comprising a motion sensor housing;
a control panel provided on the motion sensor housing and comprising controls for selecting a mode of operation of the exterior light, the mode of operation determining a time duration and conditions in which the battery is used to power the light panel assembly depending on the motion detector; and
a remote control detached from other parts of the exterior light for overriding the mode of operation from the control panel for a given period.

2. The exterior light of claim 1, wherein the remote control comprises a control component comprising a single push button.

3. The exterior light of claim 1, wherein the remote control comprises a number of control components that is less than a number of controls of the control panel.

4. The exterior light of claim 1, wherein the remote control is adapted to override the mode of operation from the control panel with one of a plurality of override modes of operations.

5. The exterior light of claim 1, wherein the mode of operation comprises a combination of at least two of: lighting duration; lighting intensity; ambient light sensitivity and motion detection sensitivity.

6. The exterior light of claim 1, further comprising a controller wherein the remote control transmits wireless signals to the controller to override the mode of operation.

7. The exterior light of claim 1, wherein the remote control comprises a wire connected to the control panel for transmitting wired signaled through the wire to override the mode of operation.

8. The exterior light of claim 1, further comprising an ambient light detector, and wherein the mode of operation depends further on the ambient light detector.

9. The exterior light of claim 1, wherein the remote control comprises a control component comprising one of an interactive graphical interface and a touch screen control.

10. The exterior light of claim 1, wherein the motion sensor housing comprises a bottom, and wherein the control panel is located on the bottom of the housing.

11. The exterior light of claim 1, further comprising a power line adapted to be connected to a power source comprising one of a solar panel and alternative current power source.

12. An exterior light comprising:
a body assembly;
a light panel assembly, attached to the body assembly, for emitting light;
a battery for powering the light panel assembly;
a controller for controlling operation of the light panel assembly;
a motion detector, connected to the controller, for detecting movement in a monitored area close to the exterior light;
a control panel, connected to the controller, comprising a control for selecting a mode of operation of the exterior light in which the battery powers the light panel assembly depending on movement detection by the motion detector; and
a remote control detached from other parts of the exterior light for providing a signal to the controller to override the mode of operation with an override mode of operation for a given period.

13. The exterior light of claim 12, wherein the remote control comprises a control component comprising a single push button.

14. The exterior light of claim 12, wherein the remote control comprises a number of control components that is less than a number of controls of the control panel.

15. The exterior light of claim 12, wherein the mode of operation comprises an operating condition of the light panel assembly and a time duration during which the battery powers the light panel assembly.

16. The exterior light of claim 15, wherein the operating condition comprises at least one of a lighting mode and a trigger condition.

17. The exterior light of claim 12, wherein the remote control is for receiving a selection the override mode of operation and for transmitting the signal of the override mode of operation among a plurality of override modes of operation.

18. The exterior light of claim 12, wherein the remote control comprises a control component comprising one of an interactive graphical interface and a touch screen control.

19. The exterior light of claim 18, wherein the mode of operation comprises a combination of at least two of: lighting duration; lighting intensity; ambient light sensitivity and motion detection sensitivity.

20. The exterior light of claim 12, wherein the remote control transmits wireless signals to the controller to override the mode of operation.
